(19) United States
(12) Patent Application Publication
(10) Pub. No.: US 2024/0044418 A1
(43) Pub. Date: Feb. 8, 2024

(54) ELECTRONIC FLUID VALVE SYSTEM

(71) Applicant: Hanon Systems, Daejeon (KR)

(72) Inventor: Emma Michelle Grissom, Howell, MI (US)

(21) Appl. No.: 17/818,090

(22) Filed: Aug. 8, 2022

(51) Int. Cl. F16K 31/524; F16K 31/04

(52) U.S. Cl. CPC F16K 31/524; F16K 31/047

(57) ABSTRACT

An electronic fluid valve system including an outer cylinder, an inner cylinder concentrically disposed within the outer cylinder, and at least one fluid valve assembly disposed between the outer cylinder and the inner cylinder. The at least one fluid valve assembly is selectively positionable between a first position and a second position, wherein in the second position the at least one fluid valve assembly is configured to selectively rotate with the inner cylinder.

### FIELD

The disclosure relates to an electronic coolant valve system, and more particularly to an electronic fluid valve system having an articulated cylinder.

### BACKGROUND

Vehicle heat exchanges, such as radiators, have coolant valves which are used to control the rate that the coolant is allowed to flow through the system. With the increase in government mandated fuel economy regulations, companies are increasingly looking for new technology that will reduce the parasitic losses and improve efficiency of internal combustion engines. Furthermore, the introduction of hybrid and fully electric vehicle powertrains has introduced powertrain coolant and thermal management complexities due to the need to control the temperature of batteries, inverter electronics, electric motors, etc. These trends lead to the need for more intelligently controlled coolant valves.

There are several key challenges in designing direct electric actuated coolant valves. First, the valve requires a relatively large flow opening, which precludes using a direct solenoid actuation system as is common in hydraulic valves. Furthermore, the coolant can often become somewhat “sludgy,” which can cause the valve to stick and fail.

Some thermostat valve manufacturers have introduced a heated wax design in which a heating element is used to expand the wax to open the valve. This provides a direct electric actuation mechanism, but does not provide for precise control. Other valve manufacturers have designs which use a diverter cylinder or diverter ball. However, these designs have an inherent trade-off between torque required to change valve positions and an amount of sealing load at the port seals. A higher sealing load results in more torque needed rotate the cylinder or ball. Additionally, it has proven difficult to control a surface finish and profile on an outer surface of the cylinder or ball to prevent an adverse impact to sealing at such surface.

Accordingly, it would be desirable to produce an electronic fluid valve system wherein a weight, a cost, and complexity thereof is minimized, while a sealing is optimized.

### SUMMARY

In concordance and agreement with the presently described subject matter, an electronic fluid valve system wherein a weight, a cost, and complexity thereof is minimized, while a sealing is optimized, have surprisingly been discovered.

In one embodiment, an electronic fluid valve system, comprises: a first cylinder; a second cylinder concentrically disposed within the first cylinder; and at least one fluid valve assembly disposed between the first cylinder and the second cylinder, wherein the at least one fluid valve assembly is selectively positionable between a first position and a second position.

In some embodiments, the first cylinder is selectively rotatable relative to the second cylinder.

In some embodiments, the electronic fluid valve system further comprises a cam mechanism configured to convert a rotational motion of one of the first cylinder and the second cylinder to a linear motion of the at least one fluid valve assembly.

In some embodiments, the electronic fluid valve system further comprises an actuator operably coupled to one of the first cylinder and the second cylinder.

In some embodiments, the at least one fluid valve assembly in the first position is in sealing engagement with a fluid structure.

In some embodiments, the at least one fluid valve assembly in the second position is in disengaged from the fluid structure and rotatable with the second cylinder.

In another embodiment, an electronic fluid valve system, comprises: a first cylinder; a second cylinder, wherein the first cylinder is selectively rotatable relative to the second; and at least one fluid valve assembly disposed between the first cylinder and the second cylinder, wherein the at least one fluid valve assembly is configured to selectively rotate with the second cylinder.

In some embodiments, the electronic fluid valve system further comprises at least one cam mechanism configured to convert a rotary motion of the first cylinder to a linear motion of the at least one fluid valve assembly.

In some embodiments, the cam mechanism is configured to cause the at least one fluid valve assembly to selectively move between a first position and a second position.

In some embodiments, the at least one fluid valve assembly includes a spigot provided on the second cylinder, a movable member coupled to the spigot, and at least one sealing element coupled to the movable member.

In some embodiments, at least one of the first cylinder, the second cylinder, the spigot, the movable member, and the sealing element includes a fluid passageway formed therein.

In some embodiments, the at least one fluid valve assembly further includes at least one biasing member disposed between the movable member and the second cylinder.

In some embodiments, the at least one fluid valve assembly further includes at least one sealing element disposed between the spigot and the movable member.

In some embodiments, the movable member includes a follower of a cam mechanism.

In some embodiments, the follower has a generally inverted “V” shape with opposing inclined portions.

In some embodiments, the first cylinder includes a cam of the cam mechanism.

In some embodiments, the cam includes at least one inclined portion configured to cooperate with the follower of the at least one fluid valve assembly to cause the at least one fluid valve assembly to move from a first position to a second position.

In some embodiments, the first cylinder further includes at least one of a plurality of engagement elements and at least one radially inwardly extending projection provided on an inner surface thereof.

In some embodiments, the second cylinder includes at least one radially outwardly extending projection provided on an outer surface thereof, wherein the at least one radially outwardly extending projection of the second cylinder is configured to cooperate with the radially inwardly extending projection of the first cylinder to facilitate rotation of the second cylinder together with the first cylinder.

In yet another embodiment, a method of sealing a port, comprises the steps of: providing a electronic fluid valve system including a first cylinder, a second cylinder, and at least one fluid valve assembly disposed therebetween; and actuating at least one of the first cylinder and the second cylinder to cause the at least one fluid valve assembly to engage and disengage.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a fragmentary view partially in section of an electronic fluid valve system according to an embodiment of the present disclosure, wherein the electronic fluid valve system is engaged with a fluid structure and at least one fluid valve assembly of the electronic fluid valve system is in an extended first position;

FIG. 2 is a fragmentary view partially in section of the electronic fluid valve system of FIG. 1, wherein the electronic fluid valve system is disengaged from the fluid structure and the at least one fluid valve assembly of the electronic fluid valve system is in a retracted second position;

FIG. 3 is a fragmentary cross-sectional view of the electronic fluid valve system of FIGS. 1 and 2, wherein the electronic fluid valve system is engaged with the fluid structure and the at least one fluid valve assembly of the electronic fluid valve system is in the first position, and wherein a first and second cylinders of the at least one fluid valve assembly are not shown;

FIG. 4 is a fragmentary cross-sectional view of the electronic fluid valve system of FIGS. 1-3, wherein the electronic fluid valve system is disengaged with the fluid structure and the at least one fluid valve assembly of the electronic fluid valve system is in the second position, and wherein the first and second cylinders of the at least one fluid valve assembly are not shown;

FIG. 5 is a schematic view of an electronic fluid valve system having a plurality of fluid valve assemblies in accordance with an embodiment of the present disclosure, wherein the electronic fluid valve system is engaged with a fluid structure and a cutaway of a first cylinder exposes an actuator including a gear in cooperation with a plurality of engagement elements formed on an inner surface thereof;

FIG. 6 is a schematic view of the electronic fluid valve system of FIG. 5, wherein the electronic fluid valve system is disengaged from the fluid structure and the cutaway of the first cylinder exposes the actuator including the gear in cooperation with the engagement elements formed on the inner surface thereof, and

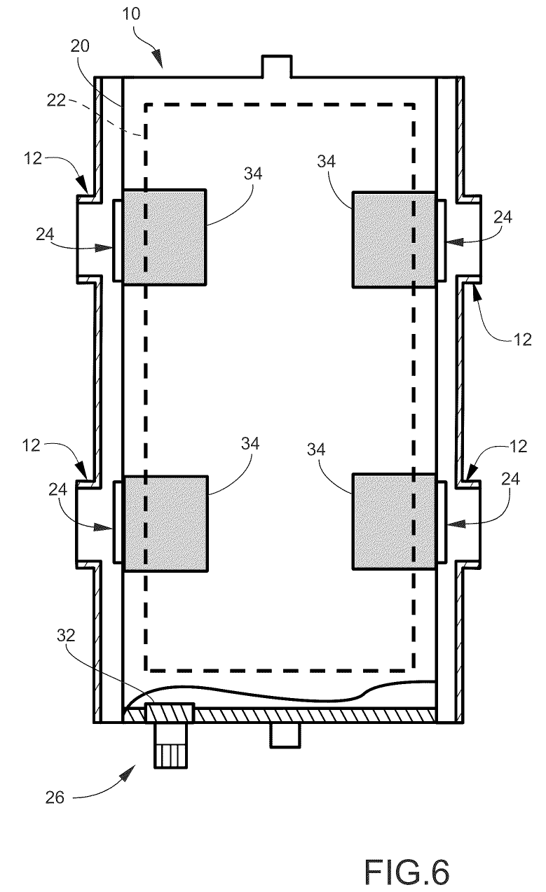

FIG. 7 is a perspective view of a fluid structure configured to receive an electronic fluid valve system having a plurality of fluid valve assemblies according to an embodiment of the present disclosure.

### DETAILED DESCRIPTION OF AN EMBODIMENT OF THE DISCLOSURE

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

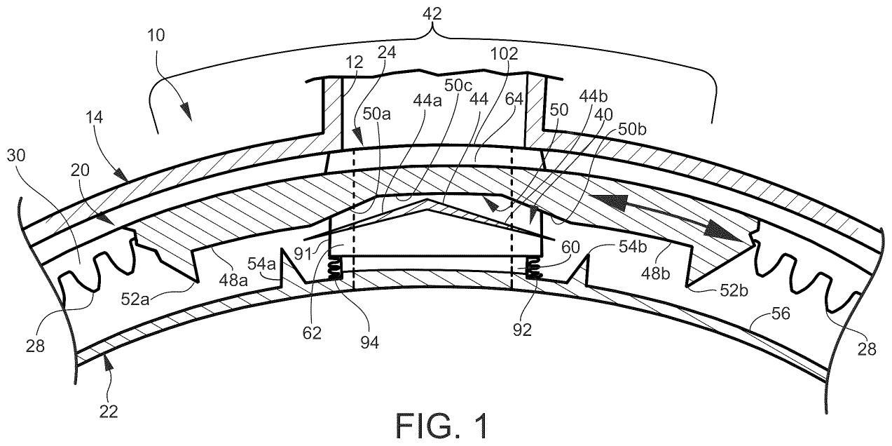

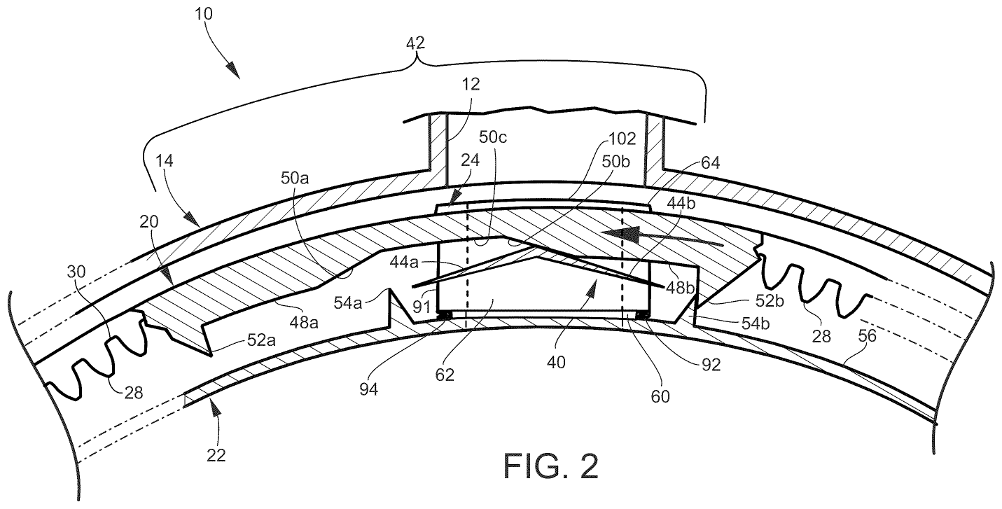

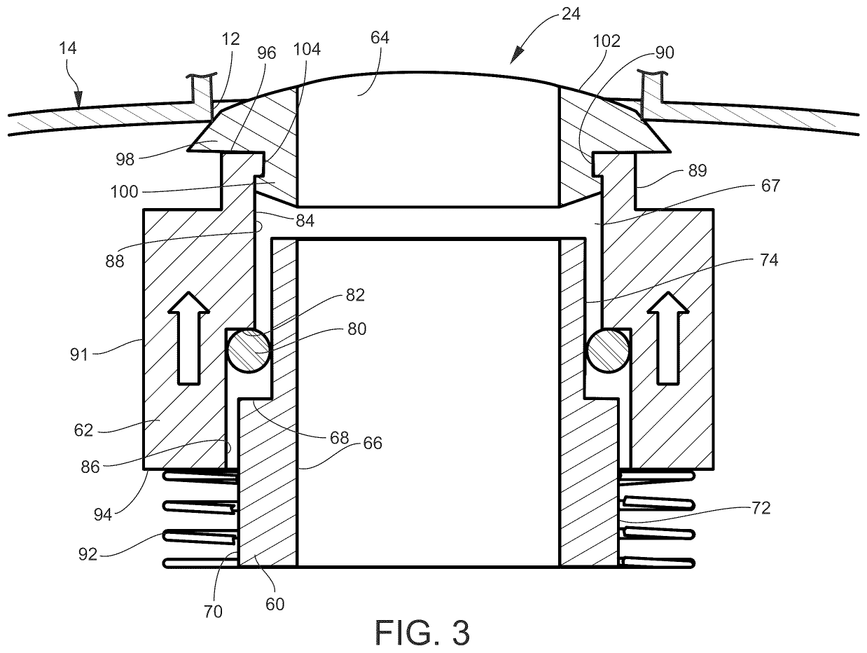

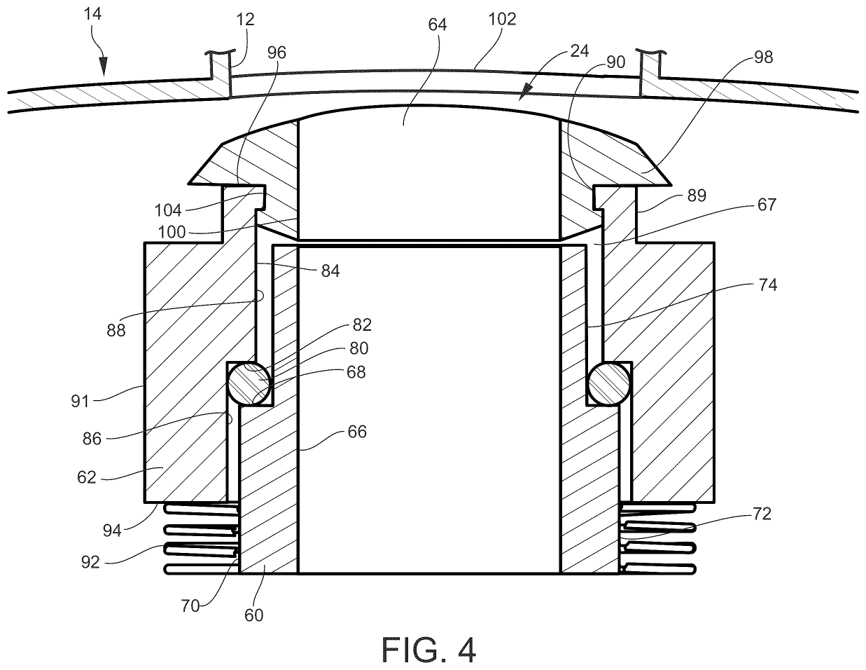

FIGS. 1-4 depict an electronic fluid valve system 10 in accordance with an embodiment of the present disclosure. FIGS. 1 and 3 illustrate the electronic fluid valve system 10 in an engaged first position. A disengaged second position of the electronic fluid valve system 10 is illustrated in FIGS. 2 and 4. The electronic fluid valve system 10 is configured to be disposed in a fluid structure 14 having one or more apertures or ports 12 such as a manifold or similar mechanism, for example. The electronic fluid valve system 10 is configured to close and open the port 12 relative to a flow of a fluid (not depicted) through the fluid structure 14.

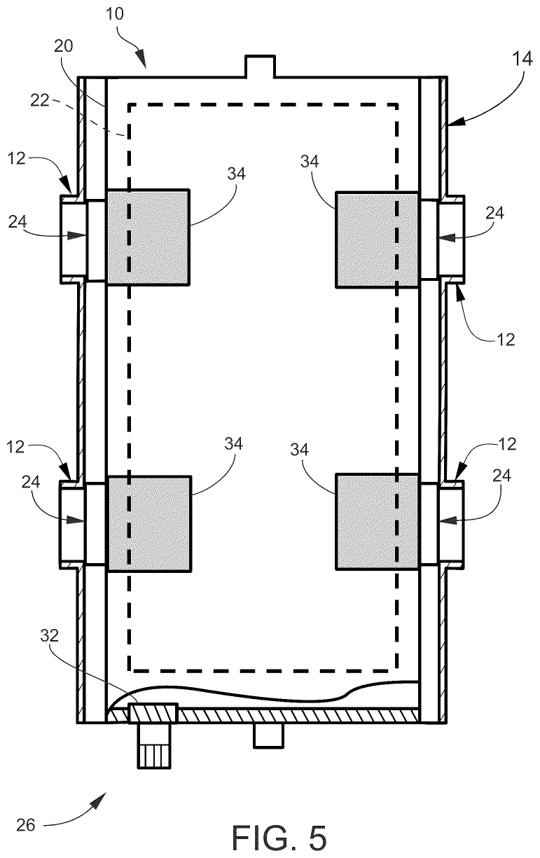

As best seen in FIGS. 1 and 2, the electronic fluid valve system 10 may comprise an outer first cylinder 20, an inner second cylinder 22 concentrically disposed within the first cylinder 20, and at least one fluid valve assembly 24 disposed between the cylinders 20, 22. In some embodiments, the first cylinder 20 is configured to selectively rotate relative to the second cylinder 22. An actuator 26, as shown in FIG. 5, may be drivingly coupled to the first cylinder 20 to cause a rotational movement thereof. The actuator 26 may cause a rotational movement of the first cylinder 20 in a first rotational direction (e.g. clockwise) and an opposite second rotational direction (e.g. counter-clockwise). More preferably, a plurality of engagement elements 28 may be formed on at least a portion of an inner surface 30 of the first cylinder 20 to cooperate with a gear 32 of the actuator 26 to cause the rotational movement of the first cylinder 20. For example, the engagement elements 28 may be formed around an entire circumference of the inner surface 30 adjacent one end of the first cylinder 20. The actuator 26 may be powered by any electric motor with an ability to generate rotary motion. For example, the actuator 26 may be driven by a stepper motor or a brushless DC (BLDC) motor. It is understood that other methods of actuation and causing the rotational movement of the first cylinder 20 may be used.

In certain embodiments, the first cylinder 20 may further include at least one opening 34, as more clearly shown in FIG. 5, formed therein. At least a portion of the at least one fluid valve assembly 24 may extend through a corresponding one of the at least one opening 34. Accordingly, the at least one opening may be configured to permit the rotational movement of the first cylinder 20 in at least one of the first and second directions. Although the electronic fluid valve system 10 shown includes four fluid valve assemblies 24 and four corresponding openings 34, it is understood that the electronic fluid valve system 10 may include any number of fluid valve assemblies 24 and the first cylinder 20 may include any number, size, and shape of the openings 34 as desired.

One or more cam mechanisms 40 of the electronic fluid valve system 10 may be employed to cause a disengagement of the at least one fluid valve assembly 24 from the port 12 of the fluid structure 14. The cam mechanism 40 may convert the rotational motion of the first cylinder 20 to a linear motion of at least a portion of the at least one fluid valve assembly 24. As illustrated, the electronic fluid valve system 10 may include one of the cam mechanisms 40 disposed on one side of the at least one fluid valve assembly 24 and another one of the cam mechanisms 40 disposed on an opposite side thereof.

In certain embodiments, the one or more cam mechanisms 40 may each include a cam 42 and a follower 44. As more clearly shown in FIGS. 1 and 2, the cam 42 may be a desired profile formed on the inner surface 30 of the first cylinder 20. For example, the desired profile may be defined by substantially planar portions 48a, 48b separated by an indentation 50 having opposing inclined portions 50a, 50b and a substantially planar center portion 50c. The follower 44 shown is provided on the fluid valve assembly 24 and has a generally inverted “V” shape with opposing inclined portions 44a, 44b. The follower 44 is configured to move along the desired profile of the cam 42 to permit the fluid valve assembly 24 to selectively move between an extended first position, as shown in FIG. 1, and a retracted second position, as shown in FIG. 2. When the follower 44 travels along the center portion 50c of the indentation 50, the fluid valve assembly 24 may be in the first position. As the follower 44 traverses either of the inclined portions 50a, 50b of the indentation 50, the fluid valve assembly 24 may be in an intermediate position between the first and second positions. When the follower 44 travels along either of the substantially planar portions 48a, 48b, the fluid valve assembly 24 may be in the second position.

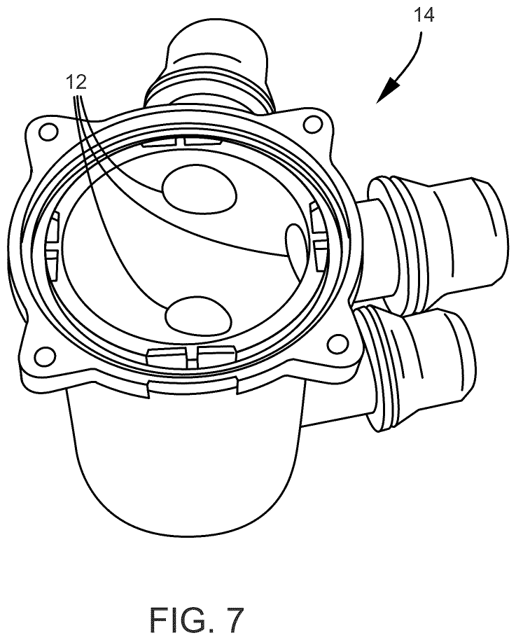

Radially inwardly extending projections 52a, 52b may be formed at ends of the substantially planar portions 48a, 48b. Each of the radially inwardly extending projections 52a, 52b is configured to engage a corresponding one of radially outwardly extending projections 54a, 54b formed on an outer surface 56 of the second cylinder 22. In certain embodiments, when one of the projections 52a, 52b is engaged with the corresponding one of the projections 54a, 54b, the second cylinder 22, and thereby the at least one fluid valve assembly 24, may be caused to rotate together with the first cylinder 20. In a non-limiting example, the cylinders 20, 22 and the at least one fluid valve assembly 24 are caused to rotate together to position the at least one fluid valve assembly 24 at other desired ports 12 formed in the fluid structure 14 such as those shown in FIG. 7.

In a preferred embodiment depicted in FIGS. 3 and 4, the at least one fluid valve assembly 24 may include a spigot 60 provided on the second cylinder 22, a movable member 62 coupled to the spigot 60, and at least one sealing element 64 coupled to the movable member 62. Each of the spigot 60, the movable member 62, and the at least one sealing element 64 shown has a generally cylindrical shape and includes respective passageways 66, 67, 69 formed therein to permit a flow of a fluid therethrough. The spigot 60 may be integrally formed with the second cylinder 22 or be a separate and distinct component, if desired. It is understood that the first cylinder 20, the second cylinder 22, the spigot 60, and the movable member 62 may be produced from any suitable material and by any method such as a three-dimensionally printed plastic material, for example. An annular shoulder 68 may be formed in an outer surface 70 of the spigot 60 defining a first portion 72 and a second portion 74 thereof. As illustrated, an outer diameter of the first portion 72 of the spigot 60 may be larger than an outer diameter of the second portion 74. An inner diameter of the portions 72, 74 may be generally constant.

At least one sealing element 80 (e.g. an O-ring) may be disposed between the spigot 60 and the movable member 62 to miliate against leakage of the fluid from the at least one fluid valve assembly 24. In certain embodiments, the sealing element 80 may be seated on the shoulder 68 of the spigot 60 and an annular shoulder 82 formed in an inner surface 84 of the movable member 62. The shoulder 82 of the movable member 62 defines a first portion 86 and a second portion 88 thereof. As illustrated, an inner diameter of the first portion 86 of the movable member 62 may be larger than an inner diameter of the second portion 88. An outer diameter of the portions 86, 88 may be generally constant. A hub-like third portion 89 may extend axially from second portion 88 of the movable member 62. The third portion 89 may include an annular lip 90 extending radially inwardly from the inner surface 84 of the movable member 62.

As best seen in FIGS. 1 and 2, an outer surface 91 of the movable member 62 may include one or more of the followers 44 of a corresponding one of the cam mechanisms 40 formed thereon. The follower 44 and the cam mechanism 40 are configured to cause the linear movement of the movable member 62 in a first axial direction from a first position, as shown in FIGS. 1 and 3, to a second position, as shown in FIGS. 2 and 4.

At least one biasing element 92 may be disposed between a first end 94 of the movable member 62 and the outer surface 56 of the second cylinder 22. Various types of biasing elements 92 may be employed such as a helical spring, for example. In the embodiment depicted, the at least one biasing element 92 may be configured to cause the linear movement of the movable member 62 in an opposite second axial direction from the second position to the first position. When the movable member 62 is in the first position, the at least one biasing element 92 may be in an extended configuration. Contrarily, when the movable member 62 is in the second position, the at least one biasing element 92 may be in a compressed configuration. It should be appreciated that other methods may be employed to cause the linear movement of the movable member 62 between the first and second positions, if desired.

A second end 96 of the movable member 62 may be configured to receive the at least one sealing element 64 thereon. In certain embodiments, the at least one sealing element 64 includes a face portion 98 and an attachment portion 100. An outer surface 102 of the face portion 98 may be generally planar, as shown in FIGS. 1 and 2, or generally curved, as shown in FIGS. 3 and 4. It is understood that the outer surface 102 of the face portion 98 may have any shape and size, as desired. An annular groove 104 may be formed in the attachment portion 100 of the at least one sealing element 64. In some embodiments, the groove 104 may be configured to receive the lip portion 90 of the movable member 62 therein to couple the at least one sealing element 64 to the movable member 62. Various other methods may be used to couple the at least one sealing element 64 to the movable member 62 such as mechanical methods (e.g. fasteners) and/or non-mechanical methods (e.g. epoxy), for example. In a preferred embodiment, at least the face portion 98 of the at least one sealing element 64 may be produced from an ethylene propylene diene monomer (EPDM). It is understood, however, that each of the face portion 98 and the attachment portion 100 of the at least one sealing element 64 may be produced from any suitable material, as desired.

When the fluid valve assembly 24 is engaged, the movable member 62 is in the first position and the at least one sealing element 64 provides a substantially fluid-tight seal between the outer surface 102 of the face portion 98 and a surface of the fluid structure 14 to permit the flow of the fluid through the passageways 66, 67, 69 and militate against a leakage therefrom. In certain embodiments such as that depicted in FIG. 1, the outer surface 102 of the face portion 98 of the at least one sealing element 64 sealing engages with an inner circumferential surface of the fluid structure 14 surrounding an opening of the port 12 to form a substantially fluid-tight seal therebetween. In other embodiments, shown in FIG. 3, for example, at least a part of the face portion 98 of the at least one sealing element 64 protrudes into the opening of the port 12 and sealing engages an inner surface of the port 12 to form a substantially fluid-tight seal therebetween. In yet other embodiments not depicted in the figures, the at least one sealing element 64 may be configured to have a portion sealing engage the inner circumferential surface of the fluid structure 14 and another portion sealing engage the inner surface of the port 12 to form a substantially fluid-tight seal therebetween.

When the fluid valve assembly 24 is at least partially disengaged, the movable member 62 is in one of the second position and an intermediate position between the first and second positions and the outer surface 102 of the face portion 98 of the at least one sealing element 64 is at least partially, if not fully, separated from the surface of the fluid structure 14 to militate against the flow of fluid through the at least one fluid valve assembly 24 and permit the at least one fluid valve assembly 24 to be positioned at another one of the ports 12, if any, formed in the fluid structure 14 such as those shown in FIG. 7.

In operation when disengagement of the fluid valve assembly 24 is desired, the actuator 26 is activated causing the rotational movement of the first cylinder 20 in one of the first or second rotational directions. Such rotational movement of the first cylinder 20 causes the movable member 62 to move in the first linear direction from the first position to the second position thereof as the follower 44 of the cam mechanism 40 traverses along the cam 42 from the planar portion 50c of the indentation 50 along one of the inclined portions 50a, 50b to one of the planar portions 48a, 48b. In certain instances, the actuator 26 is then deactivated causing the rotational movement of the first cylinder 20 to cease and the moveable member 62 to remain in the second position. In other instances, the actuator 26 remains activated causing one of the projections 52a, 52b of the first cylinder 20 to engage one of the projections 54a, 54b, resulting in the second cylinder 22, and thereby the disengaged fluid valve assembly 24, rotating together with the first cylinder 20.

In operation when engagement of the fluid valve assembly 24 is desired, the actuator 26 is activated causing the rotational movement of the first cylinder 20 in one of the first or second rotational directions. Such rotational movement of the first cylinder 20 causes the movable member 62 to move in the second linear direction from one of the second position and the intermediate position to the first position thereof as the follower 44 of the cam mechanism 40 traverses along the cam 42 from one of the planar portions 48a, 48b and the inclined portions 50a, 50b to the planar portion 50c of the indentation 50.

Unlike prior electronic coolant valve systems, the cylinders 20, 22 of the fluid valve assembly 24 of the electronic fluid valve system 10 are able to rotate without drag torque caused by stationary seals compressed between a stationary wall and a rotating cylinder. Advantageously, by retracting the sealing element 64 of fluid valve assembly 24, the first cylinder 20 and/or the second cylinder 22 is able to rotate with a lower torque. Also, by coupling the sealing element 64 to the second cylinder 22, a more robust sealing can be achieved rather than a conventional sliding face seal which can be less effective under different surface conditions.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. An electronic fluid valve system, comprising:
a first cylinder;
a second cylinder concentrically disposed within the first cylinder; and
at least one fluid valve assembly disposed between the first cylinder and the second cylinder, wherein the at least one fluid valve assembly is selectively positionable between a first position and a second position.

2. The electronic fluid valve system of claim 1, wherein the first cylinder is selectively rotatable relative to the second cylinder.

3. The electronic fluid valve system of claim 1, further comprising a cam mechanism configured to convert a rotational motion of one of the first cylinder and the second cylinder to a linear motion of the at least one fluid valve assembly.

4. The electronic fluid valve system of claim 1, further comprising an actuator operably coupled to one of the first cylinder and the second cylinder.

5. The electronic fluid valve system of claim 1, wherein the at least one fluid valve assembly in the first position is in sealing engagement with a fluid structure.

6. The electronic fluid valve system of claim 1, wherein the at least one fluid valve assembly in the second position is in disengaged from the fluid structure and rotatable with the second cylinder.

7. An electronic fluid valve system, comprising:
a first cylinder;
a second cylinder, wherein the first cylinder is selectively rotatable relative to the second; and
at least one fluid valve assembly disposed between the first cylinder and the second cylinder, wherein the at least one fluid valve assembly is configured to selectively rotate with the second cylinder.

8. The electronic fluid valve system of claim 7, further comprising at least one cam mechanism configured to convert a rotary motion of the first cylinder to a linear motion of the at least one fluid valve assembly.

9. The electronic fluid valve system of claim 8, wherein the cam mechanism is configured to cause the at least one fluid valve assembly to selectively move between a first position and a second position.

10. The electronic fluid valve system of claim 7, wherein the at least one fluid valve assembly includes a spigot provided on the second cylinder, a movable member coupled to the spigot, and at least one sealing element coupled to the movable member.

11. The electronic fluid valve system of claim 10, wherein at least one of the first cylinder, the second cylinder, the spigot, the movable member, and the sealing element includes a fluid passageway formed therein.

12. The electronic fluid valve system of claim 10, wherein the at least one fluid valve assembly further includes at least one biasing member disposed between the movable member and the second cylinder.

13. The electronic fluid valve system of claim 10, wherein the at least one fluid valve assembly further includes at least one sealing element disposed between the spigot and the movable member.

14. The electronic fluid valve system of claim 10, wherein the movable member includes a follower of a cam mechanism.

15. The electronic fluid valve system of claim 14, wherein the follower has a generally inverted “V” shape with opposing inclined portions.

16. The electronic fluid valve system of claim 14, wherein the first cylinder includes a cam of the cam mechanism.

17. The electronic fluid valve system of claim 16, wherein the cam includes at least one inclined portion configured to cooperate with the follower of the at least one fluid valve assembly to cause the at least one fluid valve assembly to move from a first position to a second position.

18. The electronic fluid valve system of claim 7, wherein the first cylinder further includes at least one of a plurality of engagement elements and at least one radially inwardly extending projection provided on an inner surface thereof.

19. The electronic fluid valve system of claim 18, wherein the second cylinder includes at least one radially outwardly extending projection provided on an outer surface thereof, wherein the at least one radially outwardly extending projection of the second cylinder is configured to cooperate with the radially inwardly extending projection of the first cylinder to facilitate rotation of the second cylinder together with the first cylinder.

20. A method of sealing a port, comprising the steps of:
providing a electronic fluid valve system including a first cylinder, a second cylinder, and at least one fluid valve assembly disposed therebetween; and
actuating at least one of the first cylinder and the second cylinder to cause the at least one fluid valve assembly to engage and disengage.
